(19) United States
(12) Patent Application Publication
(10) Pub. No.: US 2026/0232517 A1
(43) Pub. Date: Aug. 13, 2026

(54) ASSISTANCE SYSTEM FOR WALKING ASSISTANCE, COMPUTER-IMPLEMENTED METHOD FOR CONTROLLING AN ASSISTANCE SYSTEM, AND CORRESPONDING NON-TRANSITORY COMPUTER READABLE STORAGE MEDIUM

(71) Applicant: Universität Heidelberg, Heidelberg (DE)

(72) Inventors: Enrica Tricomi, Heidelberg (DE); Lorenzo Masia, Heidelberg (DE); Francesco Missiroli, Heidelberg (DE); Nicola Lotti, Heidelberg (DE)

(73) Assignee: Universität Heidelberg, Heidelberg (DE)

(21) Appl. No.: 19/152,394

(22) PCT Filed: Jan. 30, 2024
(86) PCT No.: PCT/EP2024/052263

§ 371 Date: Jul. 30, 2025

(30) Foreign Application Priority Data
Jan. 31, 2023 (EP) 23154259.8

(51) Int. Cl. A61H 3/00

(52) U.S. Cl. CPC A61H 3/00; A61H 2003/007; A61H 2201/165; A61H 2201/5069; A61H 2201/5079; A61H 2230/625

(57) ABSTRACT

The disclosure relates to an assistance system and methods configured to provide walking assistance to a user by assisting a walking movement of at least one leg of the user. The system includes an actuation control unit that has a hip joint reference trajectory unit configured to receive hip angular state information of at least one hip of the at least one leg, and generate, using a gait phase estimation model, a hip joint reference trajectory based on the received hip angular state information. The actuation control unit also includes an actuation feedback unit configured to receive a current actuator state of an actuator configured to assist the walking movement, and compare the current actuator state with the hip joint reference trajectory to generate an actuator control signal to control the actuator.

The invention relates to an assistance system configured to provide walking assistance to a user by assisting a walking movement of at least one leg of the user, a method for controlling an assistance system configured to provide walking assistance to a user, and a non-transitory computer-readable medium storing instructions for performing a method.

The invention lies in the field of assisted movement systems, in particular in the field of walking assistance systems configured to assist a walking movement a user. Specifically, parts of the population exist with reduced walking mobility and/or ability, such as for example the elderly, people with mild neurological diseases, and/or people in physical therapy/rehabilitation after injury. While such population groups may not have fully lost the ability to undertake walking movements on their own, assistance during movement of the legs, such as during a generic walking motion, may be necessary and/or desired.

It was recognised by the inventors within the scope of this invention that it is beneficial to the user of such an assisted movement system to at least partially support the natural movement of the legs of the user. Specifically, it was recognised that an accurate and timely provided assistance is necessary to ensure sufficient and/or effective support is provided.

It is therefore an object of the present invention to provide an assistance system for the movement of a user having improved simplicity, control, and operational characteristics.

According to an aspect, an assistance system is configured to provide walking assistance to a user by assisting a walking movement of at least one leg of the user. The assistance system may be a wearable soft robotic suit configured to assist lower limb joints of the at least one leg during the walking movement.

The walking movement of the at least one leg may be or comprise a natural forward movement of the user using the at least one leg and/or may be or comprise a natural backward movement of the user using the at least one leg. The walking movement may be a natural (e.g., forward and/or backward) locomotion of the user. Furthermore, please note that the present disclosure is not limited to just forward and/or backward walking movements of the user. Instead, other types of movements may also be assisted. For example, the walking movement may be or comprise a lateral movement of the user, including for example one or more lateral leg raising movements.

In particular, the walking movement may comprise at least one of a hip flexion and a hip extension of the at least one leg of the user.

The user may in particular be a human user, wherein the walking movement may be a human gait. However, the assistance system is not limited thereto, and other users having at least one leg may also be considered, such as for example an animal such as a biped.

Furthermore, walking assistance may be understood within the scope of this disclosure to relate to physical and/or mechanical assistance, such as through exertion of one or more forces, provided to the user in order to facilitate the walking movement. For example, said one or more forces may be exerted on one or both legs of the user to assist a hip flexion, e.g., during a forward and/or backward walking movement of the user. Alternatively or additionally, said one or more forces may be exerted on one or both legs of the user to assist a hip extension, e.g., during a forward and/or backward walking movement of the user. However, other types of leg movements may alternatively or additionally also be assisted.

Furthermore, the term “walking movement” may comprise walking movements at any natural speed of the user. Therefore, the term “walking movement” may be understood to, for example, also encompass slow walking, such as strolling, and/or fast walking, such as running and/or sprinting. In addition, the term “walking movement” may be understood to encompass other types of human natural movements, such as jumping and/or “skipping” movements. Further examples of possible types of human natural movements may include sitting down, such as on a chair, or standing up, such as from a sitting position. However, the disclosure is not limited thereto, and the term “walking movement” may also encompass movements of the user based on or similar to a walking motion of the user, such as for example biking.

The assistance system comprises an actuation control unit. The actuation control unit may be configured to generate at least an actuator control signal to control an actuator. The actuation control unit may be implemented on one or more printed circuit boards. For example, the actuation control unit may be implemented on an Arduino unit, such as an Arduino Mega 2560 and/or Arduino MRK Wi-Fi 1010. However, the disclosure is not limited thereto, and other means of implementation of the actuation control unit may be used. The actuation control unit may be configured to receive user data, such as hip angular state information of at least one hip of the user.

The actuation control unit comprises a hip joint reference trajectory unit. The hip joint reference trajectory unit is configured to receive the hip angular state information of at least one hip of the at least one leg of the user. The hip joint reference trajectory unit may be configured to receive the hip angular state information as a digital and/or analogue data signal. The hip angular state information may in particular describe at least one physical parameter and/or state of the at least one hip of the user.

The hip joint reference trajectory unit is further configured to generate, using a gait phase estimation model, a hip joint reference trajectory θ_{ref}(t) based on the received hip angular state information. The gait phase estimation model may be configured to estimate, preferentially based on individual parameters of the user and/or generalised parameters of a healthy user (e.g., based on population statistics of healthy users), a current and/or future physical state of the at least one hip. The gait phase estimation model may be configured to estimate a gait phase of the at least one hip. The gait phase may be indicative of a progression of the at least one hip along a gait cycle of the user. The gait phase estimation model may be a parameterized gait phase estimation model, wherein the hip joint reference trajectory unit and/or the actuation control unit may be configured to determine one or more parameters of the parameterized gait phase estimation model to adapt the parameterized gait phase estimation model to the user. The one or more parameters may for example comprise one or more scalar parameters, one or more vector parameters, and/or one or more function parameters (e.g., A sin (Bω+C), A cos (Bω+C), etc.). The hip joint reference trajectory unit may be configured to output the hip joint reference trajectory θ_{ref}(t).

The actuation control unit may further comprise an actuation feedback unit. The actuation feedback unit may be configured to receive the hip joint reference trajectory θ_{ref}(t) from the hip joint reference trajectory unit.

The actuation feedback unit is further configured to receive a current actuator state of an actuator configured to assist the walking movement of the user. The current actuator state may comprise a current actuation state of the actuator. For example, for a rotary actuator having a rotatable driving shaft, the current actuation state may comprise a rotation state and/or rotation angle and/or an angular rotation position of the rotatable driving shaft. For example, a rotary actuator may be configured to rotate the drive shaft in one or both directions (e.g., clockwise and/or counter-clockwise) around the drive shaft axis according to the actuator control signal. For example, for a linear actuator having a linearly moveable drive element, the current actuation state may comprise a current linear position of the linearly moveable drive element relative to the linear actuator. For example, a linear actuator may be configured to displace the linearly moveable drive element according to the actuator control signal.

The actuation control unit and/or the actuation feedback unit may be connectable to the actuator to receive the current actuator state and/or to output the actuator control signal. The actuation control unit and/or the actuation feedback unit may be connectable to the actuator via any data transfer protocol, such as for example via a CAN bus protocol.

The actuator may be configured to exert at least one force, directly or indirectly, on the at least one leg and/or the at least one hip to assist the walking movement based on the actuator control signal. However, exerting the at least one force may further comprise operating the actuator, based on the actuator control signal, to allow an independent movement of the at least one leg. For example, for an actuator configured to exert a pulling force on the at least one leg via at least one tendon, the actuator may be further operable to at least partially release the at least one tendon to provide slack in the at least one tendon to allow the respective at least one leg to move. In particular, the actuator may be configured to physically and/or mechanically assist the walking movement.

The actuation feedback unit is further configured to compare the current actuator state with the hip joint reference trajectory θ_{ref}(t) to generate the actuator control signal. The comparing may comprise determining, based on the hip joint reference trajectory θ_{ref}(t), a desired and/or required future actuator state. Alternatively, the hip joint reference trajectory θ_{ref}(t) may define the desired and/or required future actuator state. In particular, the hip joint reference trajectory θ_{ref}(t) may therefore, for example, define a reference position trajectory for the actuator. The comparing may further comprise comparing the future actuator state to the current actuator state to generate the actuator control signal. Therefore, the actuation feedback unit may be configured to perform a closed-loop position feedback control by generating the actuator control signal.

For example, based on such a closed-loop position feedback control, walking assistance provided by the assistance system, such as via an assistive torque exerted by the actuator, may be intrinsically scaled according to a weight of the leg of the user. The actuator may try to reach the desired and/or required future actuator state and this may result in exerting more or less assistive torque according to a load attached to the actuator (which may correspond to the weight of the respective leg). Thereby, advantageously no calibration is needed for this purpose, as kinematic considerations are common to every healthy user independently of their weight and height. This therefore may allow setting a position profile for the actuator according to a desired range of motion of the hip joint and according to a progression of the leg along the gait cycle.

The actuation control unit is further configured to output the actuator control signal to control the actuator. The actuation control unit may in particular be configured to output the actuator control signal as a digital and/or analogue signal.

By providing such an assistance system as disclosed herein, it becomes possible to efficiently at least partially support the natural movement of the legs of the user. At least partially supporting the natural movement of the legs of the user may be understood in this context as providing at least one force on the legs of the users in addition to a force exerted on the legs of the user by the user himself/herself.

The assistance system and/or the actuation control unit may be configured to be wearable by a user. For example, the assistance system may further comprise a harness configured to be worn by the user, wherein components of the assistance system, such as the actuation control unit, may be configured to be mountable on the harness. The harness may comprise one or more mounting elements, wherein the one or more mounting elements may be mountable on the user and may be configured such that one or more components of the assistance system may be (preferentially releasably) fixable on and/or to the one or more mounting elements. The one or more mounting elements may for example comprise at least one belt, such as a waist belt, and/or at least one garment, such as a trouser, and/or at least one brace, such as a knee brace.

The actuation control unit and/or the hip joint reference trajectory unit may be configured to receive the hip angular state information over a wireless and/or wired connection, for example from a sensor or input device. For example, the actuation control unit and/or the hip joint reference trajectory unit may be configured to receive, at least partially, the hip angular state information via a wireless connection, such as a Bluetooth low energy connection. In particular, the actuation control unit and/or the hip joint reference trajectory unit may therefore comprise a primary communication unit, such as a Bluetooth communication unit, configured to receive the hip angular state information. An example of a Bluetooth communication unit may be an Adafruit Feather nRF52 Bluefruit Bluetooth unit.

The hip joint reference trajectory unit and the actuation feedback unit may be implemented within a single microcontroller or as separate units connectable to one another to share power and/or information signals. For example, the hip joint reference trajectory unit may comprise a data output unit configured to output at least the hip joint reference trajectory. The actuation feedback unit may comprise a data input unit configured to receive, from the hip joint reference trajectory unit, the hip joint reference trajectory. The data output unit and the data input unit may be configured to communicate via any known data protocol, such as via wired connection (e.g., a I2C connection) and/or a wireless connection (e.g., a Bluetooth low energy connection).

The actuation control unit and/or the actuation feedback unit may comprise a control signal output unit configured to output the actuator control signal. In particular, the control signal output unit may be configured to output the actuator control signal via a wired connection and/or a wireless connection. For example, the actuation control unit and/or the actuation feedback unit may be configured to output the actuator control signal via a Bluetooth low energy connection. Alternatively, the primary data communication unit may be further configured to output the actuator control signal.

Implementing such data transfer via a wireless connection may in particular significantly simplify the assistance system. For example, hard-wired connections (e.g., between the actuation control unit and one or more sensors) may be avoided or reduced, therefore leading to a reduction in both weight and complexity of the assistance system, as well as to improvements in its ease of use. Furthermore, the reliability of the assistance system may be improved, as no or fewer wired connections may be externally exposed to potentially catch on external objects during use of the assistance system, which could lead to interruptions of the walking motion or to damage to the assistance system and/or to the respective wired connections.

The gait phase estimation model may be configured to determine a movement state and/or kinematic state of a hip, preferentially a human hip, during at least a portion of a walking cycle of a leg in dependence on at least one modelling parameter and/or the hip angular state information. The movement state and/or the kinematic state may be or comprise the gait phase indicative of a progression of the at least one hip along a gait cycle of the user, wherein the gait phase may be provided as a value in the range of 0-100% indicative of the progression along the gait cycle. The at least one modelling parameter may for example be determined based on individual parameters of the user and/or according to population statistics. Generating the hip joint reference trajectory θ_{ref}(t) may comprise evaluating the at least one modelling parameter to fit the gait phase estimation model to the user and/or to the received hip angular state information.

The hip angular state information may comprise an angular hip joint position of the at least one hip and/or an angular hip velocity of the at least one hip. Please note that the terms angular hip velocity and hip angular velocity are used interchangeably herein. The angular hip joint position of a hip may be or include a hip flexion angle measured in, for example, a sagittal plane of the user or in a plane parallel to the sagittal plane. Alternatively, the angular hip joint position may be or include an inter-limb flexion angle measured as a difference between a hip flexion angle to the sagittal plane of the left hip and a hip flexion angle to the sagittal plane of the right hip of the user. In such a case, for example, a sensor (e.g., an IMU sensor) may be mounted on a lateral side of the thigh of one or each leg of the user.

Please note that the use of the sagittal plane for the measurement of angular hip joint position information is exemplary only, and may particularly facilitate providing walking assistance for a forward and/or backward walking movement of the user. However, angular hip joint position information may, additionally or alternatively, be determined in or parallel to other planes of the user. For example, angular hip joint position of a hip may be or include a lateral hip deflection angle measured in, for example, a frontal plane of the user or in a plane parallel to the frontal plane. In such a case, for example, a sensor (e.g., an IMU sensor) may be mounted on a front or back side of the thigh of one or each leg of the user.

The hip angular velocity may be determined as the time-derivative of the angular hip joint position. This may allow a simplified setup and reduce overall data transfer requirements within the assistance system. Furthermore, the hip angular velocity may be determined as the time-derivative of the angular hip joint position by the actuation control unit and/or the hip joint reference trajectory unit. In particular, this may allow a simplified assistance system, wherein the actuation control unit may be configured to generate and output the actuator control signal based already on only a single measured input parameter type per hip, namely the corresponding angular hip joint position.

Alternatively, the hip angular velocity may be a measured hip angular velocity, for example also measured in the sagittal plane of the user or in a plane parallel to the sagittal plane. Preferably, the angular hip joint position and the hip angular velocity of a hip are measured in the same plane of the user, such as the sagittal or frontal plane of the user. For example, the angular hip joint position and/or the hip angular velocity may be measured using one or more sensors, such as one or more IMU sensors discussed further below. Such an assistance system may be more robust, as for example measurement errors of the angular hip joint position are not directly propagated to the hip angular velocity calculated based thereon.

The gait phase estimation model may be configured to receive as input the angular hip joint position and the angular hip velocity to generate the hip joint reference trajectory θ_{ref}(t).

In particular, by using the angular hip joint position and the angular hip velocity as input for the gait phase estimation model, a simple input means may be provided. Specifically, the angular hip joint position and/or the angular hip velocity may be conveniently measured using already existent, efficient sensors, such as by means of at least one inertial measurement unit (IMU) sensor. The at least one IMU sensor may, for example, be mounted on the leg, preferentially the thigh, of the respective hip.

For example, one IMU sensor may be mounted, via a thigh belt of the harness, on the or each thigh of the respective hip. In particular, no other types of sensors other than, for example, the at least one IMU sensor may be necessary, leading to a significant reduction in complexity for the assistance system.

In particular, a single sensor, e.g., a single IMU sensor, may be configured to measure kinematics of the joint, e.g., the hip angular state information. Thus, the hip joint reference trajectory for the actuator may be derived entirely by the user's motion without the need for anthropometrics scaling. Thus, by driving the actuator according to the set position profile may scale intrinsically an assistive torque exerted on the user according to a weight of the leg to be lifted to reach the desired position.

Each IMU sensor may be configured to perform a 9-axis measurement of accelerometer, gyroscope, and magnetometer, wherein the measured data is merged with a nine degrees of freedom (DoFs) fusion mode of the IMU sensor and extracted in the form of quaternions to obtain a femur inclination with respect to a vertical axis. The vertical axis may be defined in relation to an external coordinate system, such as a cartesian or polar coordinate system, and may, for example, extend along the direction of gravity. Thereby, a facile means may be realised for obtaining the femur inclination particularly suited for assisting an upright walking movement of the user.

Alternatively or additionally, an additional sensor unit, such as an additional IMU sensor, may be provided on a waist of the user, such as for example on a waist belt of the harness. The additional sensor unit may be configured to obtain and/or measure a spine inclination, preferentially of a spine axis extending substantially along and/or parallel to a spine of the respective user with respect to the vertical axis. Using at least one IMU sensor mounted on the at least one leg, preferentially the at least one respective thigh, of the respective hip, and the additional sensor unit provided on the waist of the user, a relative femur inclination may be obtained relative to the spine axis extending substantially along and/or parallel to a spine of the respective user. Specifically, it may therefore be possible to obtain the relative femur inclination even in situations, wherein the user does not engage in an upright walking movement, such as for example during crouched and/or bent-over movement of the user. For an upright walking movement of the user, the relative femur inclination may be substantially identical to the femur inclination, as discussed above.

The thus obtained femur inclination and/or the obtained relative femur inclination may be a good and/or sufficient approximation of the angular hip joint position, such as for example a hip flexion angle. In particular, the obtained femur inclination and/or the obtained relative femur inclination may be output by the at least one IMU sensor as the angular hip joint position to the actuation control unit and/or the hip joint reference trajectory unit. An exemplary IMU sensor that could be used with the present disclosure is the Bosch BNO055 sensor. However, the present disclosure is not limited to any specific IMU sensor. Data communication within the sensor, such as a first sensor unit as further described below, and/or within the actuation control unit may be undertaken via a plurality of data transfer protocols, such as for example I2C and/or SPI.

The gait phase estimation model may be further configured to determine a polar angle between the angular hip joint position and the angular hip velocity in a hip-phase-portrait. A hip-phase-portrait may be understood as a graphical representation of hip kinematics of the at least one hip in hip phase space. In particular, hip phase space may be a mathematical space spanned by an angular hip joint position abscissa axis, such as a hip flexion angle abscissa axis, and a hip angular velocity ordinate axis. Based on the received angular hip joint position and hip angular velocity at any timepoint t, a corresponding polar angle may be determined in the hip phase space.

Furthermore, it was realised within the scope of the present invention that during the walking movement, e.g., during natural human locomotion, the angular hip joint position θ(t) may exhibit a periodic trajectory, which may for example be approximated to a sinusoidal waveform, wherein the hip angular velocity \dot{θ}(t) may also exhibit a periodic trajectory. The hip angular velocity \dot{θ}(t) may have π/2 shift with respect to the angular hip joint position θ(t). The angular hip joint position θ(t) and the hip angular velocity \dot{θ}(t) may therefore produce a (for example counter-clockwise or clockwise) circular orbit in hip phase space.

The polar angle may be the angle between the angular hip joint position θ(t) and the hip angular velocity \dot{θ}(t) in hip phase space, and may be indicative of a progression of the walking movement along a gait cycle.

The gait phase estimation model may be further configured to determine an estimated gait phase φ(t) indicative of a progression of the walking movement along the gait cycle based on the polar angle. For example, the estimated gait phase φ(t) may therefore be obtained as a function of the angular hip joint position θ(t) and the hip angular velocity \dot{θ}(t) (i.e., as φ(t)=f([θ(t), \dot{θ}(t)])). In particular, the estimated gait phase φ(t) may be a monotonically increasing variable.

The gait phase estimation model may be further configured to, prior to determining the estimated gait phase, center and normalize the angular hip joint position θ(t) and the hip angular velocity \dot{θ}(t). In addition, the polar angle may be determined between the centered and normalized angular hip joint position, and the centered and normalized hip angular velocity.

In particular, by undertaking such a centering and normalization, a linearity of the determined estimated gait phase φ(t) may be improved for each stride. Furthermore, such a centering and normalization may allow a more circular orbit of the angular hip joint position θ(t) and the hip angular velocity \dot{θ}(t) in hip phase space.

The centering and normalization may comprise shifting the angular hip joint position θ(t) and the hip angular velocity θ(t) about the origin of the hip phase space and/or the hip-phase portrait. The centering and normalization may further comprise scaling the angular hip joint position θ(t) to match an amplitude of the hip angular velocity θ(t). An example of such a centering and normalization, which may be used for the present disclosure, is shown in David Quintero et al.: “Real-Time Continuous Gait Phase and Speed Estimation from a Single Sensor”, in 2017 IEEE Conference on Control Technology and Applications (CCTA), pp. 847-852, IEEE, 2017, which is incorporated in its entirety herein.

A centered and normalized angular hip joint position θ(t) may be obtained by the following formula:

$$\hat{θ} ( t ) = \frac{\vert {\dot{θ}}_{{max}_{i}} ( t ) - {\dot{θ}}_{{min}_{i}} ( t ) \vert}{\vert {θ}_{{max}_{i}} ( t ) - {θ}_{{min}_{i}} ( t ) \vert} ( θ ( t ) - \frac{{θ}_{{max}_{i}} ( t ) + {θ}_{{min}_{i}} ( t )}{2} )$$

A centered and normalized hip angular velocity θ(t) may be obtained by the following formula:

$$\hat{\dot{θ}} ( t ) = \pm ( \dot{θ} ( t ) - \frac{{\dot{θ}}_{{max}_{i}} ( t ) + {\dot{θ}}_{{min}_{i}} ( t )}{2} )$$

In the above equation the sign “±” is dependent of the respective leg and/or hip under consideration, and may therefore be adapted accordingly. Specifically, the sign may further determine the rotation direction (clockwise or counter-clockwise) of the circular orbit in hip phase space. For example, for considering the right leg of the user the equation may use ±=(−1), while for considering the left leg of the user the equation may use ±=(+1), leading to a counter-clockwise circular orbit in hip phase space, respectively.

The maximum values, \dot{θ}ₘₐₓ_{ᵢ}(t) and θₘₐₓ_{ᵢ}(t), and the minimum values, \dot{θ}ₘᵢₙ_{ᵢ}(t) and θₘᵢₙ_{ᵢ}(t), may be related to the i^{th} stride and may be identified as the times in which the derivatives of the respective signals, \dot{θ}(t) and \ddot{θ}(t), cross zero. In particular, a zero crossing of the derivative of a signal may correspond to a local extremum (i.e., a local maximum/minimum). Furthermore, the nature of the local extremum (i.e., whether the local extremum is a local maximum or minimum) may be determined on the basis of the direction, from which the respective derivative approaches zero (e.g., from positive to negative values in the y-axis or vice versa).

For example, the estimated gait phase φ(t) may therefore be obtained as a function of the centered and normalized angular hip joint position \hat{θ} (t) and the centered and normalized hip angular velocity \hat{\dot{θ}}(t) (i.e., as φ(t)=f([\hat{θ}(t), \hat{\dot{θ}}(t)])).

The estimated gait phase φ(t) may for example be obtained using the following formula, using the Iverson bracket notation:

$$φ ( t ) = a tan ( \frac{\hat{\dot{θ}} ( t )}{\hat{θ} ( t )} ) [ \hat{θ} ( t ) \neq 0 ] + η ( t )$$

The term η(t) may be a corrective factor to consider that for each value of the angular hip joint position θ(t) there are at least two solutions due to the back-and-forth movement of the hips during the walking movement. Therefore, a correct value for the estimated gait phase φ(t) may be disambiguated by summing the sign function of the centered and normalized hip angular velocity \hat{\dot{θ}}(t). For example, the corrective factor η(t) may therefore be given by (again using the Iverson bracket notation):

$$η ( t ) = sgn ( \hat{\dot{θ}} ( t ) ) ( π [ \hat{θ} ( t ) < 0 ] + \frac{π}{2} [ \hat{θ} ( t ) = 0 ] )$$

The gait phase estimation model may be further configured to approximate, based on the estimated gait phase, a dynamic behaviour θᵣ(t) (which may also be referred to as the approximated dynamic behaviour θᵣ(t) herein) of the at least one hip, wherein the hip joint reference trajectory θ_{ref}(t) is generated based on the approximated dynamic behaviour θᵣ(t). The approximated dynamic behaviour θᵣ(t) may in particular approximate a sinusoidal-like behaviour of the at least one hip joint in the sagittal plane.

For example, the approximated dynamic behaviour θᵣ(t) may be obtained by:

$${θ}_{r} ( t ) = sin ( φ ( t ) )$$

The gait phase estimation model may be further configured to apply a Kalman filter to the approximated dynamic behaviour θᵣ(t) of the at least one hip prior to generating the hip joint reference trajectory θ_{ref}(t).

In particular, it was recognised within the scope of the present invention, that the generated hip joint reference trajectory θ_{ref}(t) may be sensitive to noise captured during the measurement and/or determination of the angular hip state information. This noise, for example, may be caused during a heel strike at sustained speeds of the user and/or may be due to shifting movements of the assistance system on the user, such as by a shifting movement of the harness mounted on the user. It was therefore recognised that any such noise may be transferred to information and values determined on the basis of the angular hip state information, such as for example to the hip joint reference trajectory θ_{ref}(t).

However, by applying a Kalman filter to the approximated dynamic behaviour θᵣ(t) of the at least one hip prior to generating the hip joint reference trajectory θ_{ref}(t) such a transfer of noise may be significantly reduced and/or avoided. Therefore, it becomes possible to improve a robustness to noise and enhance the overall control characteristics of the assistance system.

For example, applying the Kalman filter allows a rejection of noise according to signal noise characteristics and modelling, contrarily to common low-pass or high-pass filters that require the identification of a specific cut-off frequency. However, the noise captured during the measurement and/or determination of the angular hip state information may not have a constant pattern as it may, for example, derive from sensor movements of a structure of the assistance system while the user is moving. Under such conditions, while it may not be possible to identify a specific cut-off frequency and apply a common low/high pass filter, application of a Kalman filter as described herein is still capable of significantly reducing and/or avoiding the transfer of noise.

The Kalman filter may be applied in the following fashion:

$$[ \begin{matrix}{\hat{θ}}_{{r}_{t}} \\ {\hat{\dot{θ}}}_{{r}_{t}}\end{matrix} ] = A [ \begin{matrix}{\hat{θ}}_{{r}_{t - 1}} \\ {\hat{\dot{θ}}}_{{r}_{t - 1}}\end{matrix} ] + {K}_{t} ( {θ}_{{r}_{t}} - C [ \begin{matrix}{\hat{θ}}_{{r}_{t - 1}} \\ {\hat{\dot{θ}}}_{{r}_{t - 1}}\end{matrix} ] )$$

The above equation may compute a measurement update of the approximated dynamic behaviour θᵣ(t) at each iteration. The vector

$$[ \begin{matrix}{\hat{θ}}_{{r}_{t}} \\ {\hat{\dot{θ}}}_{{r}_{t}}\end{matrix} ]$$

may be a current state estimate (e.g., trajectory and its derivative), the vector

$$[ \begin{matrix}{\hat{θ}}_{{r}_{t - 1}} \\ {\hat{\dot{θ}}}_{{r}_{t - 1}}\end{matrix} ]$$

may be a predicted state estimate given past measurements of θᵣ(t) up to time t−1, and/or Or, may be the current approximated dynamic behaviour θᵣ(t).

The term A may be a system matrix, and may for example be given by:

$$A = [ \begin{matrix}1 & Δ t \\ 0 & 1\end{matrix} ]$$

In particular, Δt may be a time interval of each update cycle of the actuation control unit. Therefore, matrix A may take hardware considerations of the actuation control unit into account. Thus, for an actuation control unit operating with an update cycle time interval of Δt=0.01 s (e.g., at a frequency of 100 Hz), the matrix A may be given by:

$$A = [ \begin{matrix}1 & 0.01 \\ 0 & 1\end{matrix} ]$$

The term C may be an output matrix, and may for example by given by:

$$C = [ \begin{matrix}1 & 0\end{matrix} ]$$

The term Kₜ may be the Kalman gain and may determine noise characteristics, wherein said noise characteristics may be set by means of a process noise covariance matrix Q and a measurement noise covariance matrix R:

$${K}_{t} = ( {APC}^{T} ) {( {CPC}^{T} + R )}^{- 1}$$

$$P = {AP}_{t - 1} {A}^{T} + Q$$

The term P may be a state covariance matrix and may be chosen to minimize the error in the estimate. The process noise covariance matrix Q and the measurement noise covariance matrix R may for example be given by:

$$Q = [ \begin{matrix}0.02 & 0 \\ 0 & 0.02\end{matrix} ]$$

$$R = 0.75$$

The dimensions of the process noise covariance matrix Q may be the same dimensions as the system matrix A, and may therefore for example be 2×2. The dimensions of the measurement noise covariance matrix R may be the same dimensions as the measurement, and may therefore for example be 1×1 (as the measurement may be scalar, e.g., measurements of θᵣ(t)).

The values along the diagonal of the matrices Q and R above (e.g., 0.02 and 0.75 in the example above) may be chosen as weighting factors for the noise of the estimate or the noise of the measurement, respectively.

The above recited values for the system matrix A, output matrix C, the process noise covariance matrix Q, and the measurement noise covariance matrix R are exemplary only. In particular, values for Q and R may be experimentally determined based on a specific hardware implementation of the assistance system.

The assistance system may be configured to execute a Kalman configuration process prior to starting the provision of walking assistance during the walking movement. The assistance system may in particular be configured to determine, during the Kalman configuration process, one or more values for A, C, Q, and/or R. Alternatively or additionally, one or more values for A, C, Q, and/or R may be predetermined and provided to the assistance system during the Kalman configuration process.

The gait phase estimation model may be further configured to generate the hip joint reference trajectory θ_{ref}(t) by applying an interpolation to the approximated dynamic behaviour θᵣ(t) of the at least one hip. In particular, in embodiments where the Kalman filter is applied to the approximated dynamic behaviour θᵣ(t), the interpolation may be applied to the Kalman filtered approximated dynamic behaviour. In other words, in embodiments where the Kalman filter is applied to the approximated dynamic behaviour θᵣ(t), the interpolation may be applied to the approximated dynamic behaviour θᵣ(t) of the at least one hip after the Kalman filter has been applied to the approximated dynamic behaviour θᵣ(t) of the at least one hip. The interpolation may in particular be a motion mapping method based on a cubic spline interpolation. The interpolation may further take into account the specific hardware configuration of the actuator. For example, for an actuator configured to assist the walking movement of one leg only (e.g., as for example for single leg assistance systems and/or fully actuated assistance systems), the hip joint reference trajectory θ_{ref}(t) may be asymmetric. In other words, such an actuator may for example pull a tendon a first amount when a corresponding hip flexes and release (or, in other words, provide slack in) the respective tendon a second amount when the hip extends, wherein the first amount is larger than the second amount.

The interpolation may be any kind of interpolation, such as polynomial interpolation. Cubic spline interpolation may be a special form of polynomial interpolation, wherein intervals between data points of the approximated dynamic behaviour θᵣ(t) (e.g., with or without applied Kalman filter) may be fitted with 3^{rd} degree polynomials such that the curvature of the hip joint reference trajectory θ_{ref}(t) is adjusted as needed. Such 3^{rd} degree polynomials may take the form of:

$$S ( x ) = a + bx + {cx}^{2} + {dx}^{3}$$

The gait phase estimation model may be configured to, prior to applying the interpolation to the approximated dynamic behaviour θᵣ(t) of the at least one hip, calibrate the interpolation. Calibrating the interpolation, e.g., the cubic spline interpolation, may comprise calibrating the interpolation such that a force generated by the actuator, such as a pulling force generated by the actuator on a tendon, based on the actuator control signal is amplified during hip flexion, while a slack is provided by the actuator, such as slack provided by the actuator in the tendon to cover approx. 10° to approx. 15° of extension without amplification, during hip extension. Calibrating the interpolation may further be adjusted experimentally to account for hardware considerations of the assistance system. For example, calibrating the interpolation may be experimentally adjusted to account for the gait phase (for example, as determined above), a desired amount of assistance (given, for example, as a value relative to a force exerted by the user himself), and/or the hardware of the actuator (such as a radius of a pulley wrapping the tendon in a rotary actuator).

The hip joint reference trajectory θ_{ref}(t) may in particular correspond to the desired and/or required future actuator state, such as a desired and/or required future motor position. The hip joint reference trajectory θ_{ref}(t) may therefore be further determined based on a hip range of motion exerted by the user and/or actuator range of motion and/or, for example, a radius of a drive shaft and/or pulley of the actuator.

The gait phase estimation model may be further configured to, after applying the interpolation to the approximated dynamic behaviour θᵣ(t) of the at least one hip, summing up to the hip joint reference trajectory θ_{ref}(t) a speed proportionality factor, wherein the speed proportionality factor may be related to and/or based on the walking speed of the user. For example, the speed proportionality factor may be the gait speed s_{gait}, as further discussed below.

The actuation feedback unit may be a Proportional-Integral-Differential, PID, controller or PID-like controller. The current actuator state may be a motor position θₘ(t). The actuation feedback unit may be configured to determine a positional error (θ_{ref}(t)-θₘ(t)), wherein the actuation unit may be configured to convert the positional error into the actuator control signal, such as a motor angular velocity. For example, the actuation feedback unit (e.g., the PID or PID-like controller) may be configured to generate the actuator control signal based on the positional error, wherein the PID controller may have the following transfer function:

$$Y ( s ) = \frac{{K}_{p} + {K}_{i} \cdot \frac{1}{s}}{1 + {K}_{d} \cdot s}$$

The gains Kₚ, Kᵢ, and K_{d} may be pre-determined, such as for example by using the Ziegler-Nichols heuristic method, to accurately follow the desired hip joint reference trajectory θ_{ref}(t).

The actuation control unit may be further configured to determine whether the user stops walking, wherein determining whether the user stops walking may comprise evaluating whether a stop condition is met. When the actuation control unit determines that a user has stopped walking, the actuation control unit may be configured to set the actuator control signal to 0, preferably as long as it is determined that the user has stopped walking. Preferably, the actuation control unit is configured to periodically, preferentially continuously, evaluate whether the user stops walking and/or has stopped walking.

The actuation control unit may be further configured to determine a gait speed s_{gait} of the user. The gait speed may be determined based on the received hip angular state information, preferably based on at least the angular hip joint position and the hip angular velocity. For example, the gait speed s_{gait} may be obtained by the following equation:

$${s}_{gait} = \sqrt{{\hat{θ} ( t )}^{2} + {\hat{\dot{θ}} ( t )}^{2}}$$

In particular, by relying on the centered and normalized angular hip joint position \hat{θ}(t) and centered and normalized hip angular velocity θ(t), an accurate and efficient determination of the gait speed s_{gait} may be enabled.

However, it is noted that the gait speed s_{gait} may also be determined on the basis of the angular hip joint position θ(t) and the hip angular velocity \dot{θ}(t), as received by the hip joint reference trajectory unit and/or without corresponding centering and normalization:

$${s}_{gait} = \sqrt{{θ ( t )}^{2} + {\dot{θ} ( t )}^{2}}$$

Such an approach may allow for a more rapid determination of the gait speed s_{gait} and consequently may allow a more rapid evaluation of whether the stop condition is met.

Preferentially, the actuation control unit may be configured to evaluate whether the stop condition is met prior to generating the hip joint reference trajectory θ_{ref}(t). In particular, an efficient operation of the assistance system may therefore be allowed.

In particular, evaluating whether the stop condition is met may comprise comparing the gait speed s_{gait} with a stop threshold value τₛ_{_{gait}}. In particular, evaluating whether the stop condition is met may comprise determining that the gait speed s_{gait} is below the stop threshold value τₛ_{_{gait}} Preferentially, the stop threshold value τₛ_{_{gait}} may be set at approximately τₛ_{_{gait}}=0.22 rad/s.

However, the stop threshold value τₛ_{_{gait}} is not limited to the above exemplary value. Instead, the stop threshold value τₛ_{_{gait}} may be determined individually for each user, or may be set to a standard value. The standard value may for example be based on population statistics. Individually determining the stop threshold value τₛ_{_{gait}} for each user may comprise determining the stop threshold value τₛ_{_{gait}} based on the individual range of motion of the at least one leg of the user. Furthermore, a stop threshold value τₛ_{_{gait}} it may be individually determined for each leg of the user, which may allow individually evaluating whether the stop condition is met for each leg separately.

In particular, a value of the stop threshold value τₛ_{_{gait}} may be experimentally determined. For example, the stop threshold value τₛ_{_{gait}} may be determined to take into account hardware considerations of the assistance system, noise introduced by measurements (such as the hip angular state information), whether any data processing is undertaken on the hip angular state information (such as by centering and normalization and/or by application of a Kalman filter, as discussed above). If the hip angular state information is filtered, for example as discussed above, the stop threshold value may take into account any cut frequency of the corresponding filter.

For example, the value of the stop threshold value τₛ_{_{gait}} may be determined based on population statistics. For instance, an assistance system according to the present disclosure may be mounted on a pool of N subjects at rest and in quiet standing, wherein a respectively determined value of the gait speed s_{gait} may be recorded. The value of the stop threshold value τₛ_{_{gait}} may be estimated based on said respectively determined values of the gait speed s_{gait} as an average. However, while this already may be sufficient for determining the value of the stop threshold value τₛ_{_{gait}}, it is noted that these respectively determined values of the gait speed s_{gait} may further intrinsically contain noise of the corresponding sensors. Therefore, robustness may be further increased by asking the N subjects to walk and suddenly stop to measure the required value of the stop threshold value τₛ_{_{gait}} after motion and accounting for more variability in the corresponding stop threshold value dataset before finding the average value.

Furthermore, the actuation control unit may be configured to evaluate whether the stop condition is met prior to the application of the Kalman filter and the interpolation, as described above. In particular, this may allow the actuator control signal to smoothly approach zero and thus may avoid abrupt changes and/or discontinuities in the actuator control signal.

Setting, when the actuation control unit has determined that the user has stopped walking, the actuator control signal to 0 may comprise setting the approximated dynamic behaviour θᵣ(t) to zero (which, in turn, may result in the actuator control signal to be set to zero).

Furthermore, setting the approximated dynamic behaviour θᵣ(t) to zero may comprise setting the approximated dynamic behaviour θᵣ(t) to zero prior to the application of the Kalman filter and/or the interpolation, as discussed above. In particular, applying the Kalman filter and/or the interpolation to the approximated dynamic behaviour θᵣ(t) after the approximated dynamic behaviour θᵣ(t) has been set to zero may allow the actuator control signal to smoothly approach to zero. This may for example reduce stress on both the assistance system and the user during use of the assistance system. Furthermore, a more natural walking assistance may be thereby provided when the user has stopped walking.

By implementing such a stop condition, the actuation control unit may avoid and/or reduce disturbances and/or noise in the hip angular state information from translating into unwanted actuator control signals when the user stops walking.

The assistance system may in particular be configured to provide walking assistance to a user by assisting a walking movement of a first leg of the user.

The assistance system may comprise a first sensor unit communicatively coupled to the actuation control unit and configured to determine an angular hip joint position and an angular hip velocity of a first hip of the first leg of the user. The first hip of the first leg of the user may in particular be a hip directly connected to the first leg. The first sensor unit may be mountable on the first leg of the user, such as on a harness worn by the user at least partially on the first leg. For example, the harness may comprise a first leg belt, e.g., a first thigh belt, configured to be worn by the user on the first leg, wherein the first sensor unit is mountable on the first leg belt.

The first sensor unit may be configured to provide, as the hip angular state information, the angular hip joint position and an angular hip velocity of the first hip to the hip joint reference trajectory unit, preferably via a wireless (e.g., Bluetooth low energy) connection. The actuation control unit may be in particular configured to generate the actuator control signal based on the angular hip joint position and the angular hip velocity of the first hip. The first sensor unit may comprise an IMU sensor, such as a Bosch BNO055 sensor, and a data communication unit, such as a Feather nRF52 unit.

The assistance system may further comprise the actuator, wherein the actuator is configured to exert at least one force, preferentially a pulling force, on the first leg of the user based on the actuator control signal. The actuator may be mountable on the user, such as on the harness worn by the user. For example, the harness may comprise a waist belt configured to be worn by the user, wherein the actuator is mountable on the waist belt. The actuator may be configured as a rotary actuator having a rotatable drive shaft. The actuator may further comprise at least one tendon at least partially wound around the rotatable drive shaft. The tendon may further be fixedly connected to the first leg belt. Therefore, the actuator may be configured to rotate, in particular based on the actuator control signal, the drive shaft to wind up the at least one tendon to exert the at least one force on the first leg.

Furthermore, the actuation control unit may be configured to determine and/or calculate an angular hip joint position and an angular hip velocity of the second hip of the user based on the received angular hip joint position and the received angular hip velocity of the first hip. Specifically, it was realised within the scope of the present invention that, for example during continuous walking movement, hip angular state information of a first hip of the user is related, for example via a phase shift, to hip angular state information of the second hip of the user. In particular, in such an assistance system the provision and/or number of further sensor units, such as a second sensor unit, mounted on the other leg of the user may be avoided and/or reduced.

The assistance system may in particular be configured to provide a fully actuated walking assistance to a user by assisting a walking movement of a first leg of the user and a second leg of the user. A fully actuated walking assistance system may in particular comprise one actuator for each leg, to which assistance is to be provided.

The assistance system may comprise a first sensor unit communicatively coupled to the actuation control unit and configured to determine an angular hip joint position and an angular hip velocity of a first hip of the first leg of the user. The first sensor unit may in particular be configured as described above.

The assistance system may further comprise a first actuator, wherein the first actuator is configured to exert at least one force, preferentially a pulling force, on the first leg of the user based on a first actuator control signal. The first actuator may be mountable on the user, such as on the harness worn by the user. For example, the harness may comprise a waist belt configured to be worn by the user, wherein the first actuator is mountable on the waist belt. The first actuator may be configured as a rotary actuator having a rotatable drive shaft. The first actuator may further comprise at least one first tendon at least partially wound around the rotatable drive shaft. The first tendon may further be fixedly connected to the first leg belt. Therefore, the first actuator may be configured to rotate, in particular based on the first actuator control signal, the drive shaft to wind up the at least one first tendon to exert the at least one force on the first leg.

The first sensor unit may be configured to provide the angular hip joint position and an angular hip velocity of the first hip to the hip joint reference trajectory unit, wherein the hip joint reference trajectory unit may be configured to generate, using the gait phase estimation model, a first hip joint reference trajectory θ_{ref,1}(t) based on the received angular hip joint position and angular hip velocity of the first hip.

The actuation feedback unit may be configured to receive a first current actuator state of the first actuator. The actuation feedback unit may be further configured to compare the first current actuator state with the first hip joint reference trajectory θ_{ref,1}(t) to generate the first actuator control signal. The actuation control unit may be configured to output the first actuator control signal to the first actuator to control the first actuator.

The assistance system may further comprise a second sensor unit communicatively coupled to the actuation control unit and configured to determine an angular hip joint position and an angular hip velocity of a second hip of the second leg of the user. The second hip of the second leg of the user may be a hip directly connected to the second leg. The second sensor unit may be mountable on the second leg of the user, such as on the harness worn by the user at least partially on the second leg. For example, the harness may comprise a second leg belt, e.g., a second thigh belt, configured to be worn by the user on the second leg, wherein the second sensor unit is mountable on the second leg belt. The second sensor unit may comprise an IMU sensor, such as a Bosch BNO055 sensor, and a data communication unit, such as a Feather nRF52 unit.

The assistance system may further comprise a second actuator, wherein the second actuator is configured to exert at least one force, preferentially a pulling force, on the second leg of the user based on a second actuator control signal. The second actuator may be mountable on the user, such as on the harness worn by the user. For example, the harness may comprise a waist belt configured to be worn by the user, wherein the second actuator is mountable on the waist belt. The second actuator may be configured as a rotary actuator having a rotatable drive shaft. The second actuator may further comprise at least one second tendon at least partially wound around the rotatable drive shaft. The second tendon may further be fixedly connected to the second leg belt. Therefore, the second actuator may be configured to rotate, in particular based on the second actuator control signal, the drive shaft to wind up the at least one second tendon to exert the at least one force on the second leg. Both the first actuator and the second actuator may be mounted on the same waist belt.

The second sensor unit may be configured to provide the angular hip joint position and an angular hip velocity of the second hip to the hip joint reference trajectory unit, wherein the hip joint reference trajectory unit may be configured to generate, using the gait phase estimation model, a second hip joint reference trajectory θ_{ref,1}(t) based on the received angular hip joint position and angular hip velocity of the second hip.

The actuation feedback unit may be configured to receive a second current actuator state of the second actuator. The actuation feedback unit may be further configured to compare the second current actuator state with the second hip joint reference trajectory θ_{ref,1}(t) to generate the second actuator control signal. The actuation control unit may be configured to output the second actuator control signal to the second actuator to control the second actuator.

Therefore, an efficient provision of walking assistance may be enabled for fully actuated assistance systems.

Furthermore, it is noted that, while the above exemplary embodiment is discussed on the basis of providing a single actuation control unit configured to output the first actuator control signal to the first actuator to control the first actuator and to output the second actuator control signal to the second actuator to control the second actuator, the disclosure is not limited thereto. For example, the assistance system may further comprise an actuation control unit for each leg, to which assistance is to be provided. Each of these actuation control units for each leg may be configured as an actuation control unit, as described herein. In such a case, the assistance system may for example comprise a first actuation control unit configured to generate and output the first actuator control signal to the first actuator to control the first actuator, and a second actuation control unit configured to generate and output the second actuator control signal to the second actuator to control the second actuator.

The assistance system may in particular be configured to provide an under-actuated walking assistance to a user by assisting a walking movement of a first leg of the user and a second leg of the user. An under-actuated walking assistance system may in particular comprise one actuator for both legs to which assistance is to be provided.

The assistance system may comprise a first sensor unit communicatively coupled to the actuation control unit and configured to determine at least an angular hip joint position of a first hip of the first leg of the user. The first sensor unit may in particular be configured as described above.

The assistance system may further comprise a second sensor unit communicatively coupled to the actuation control unit and configured to determine at least an angular hip joint position of a second hip of the first leg of the user. The second sensor unit may in particular be configured as described above.

The assistance system may further comprise the actuator, wherein the actuator is configured to exert at least one force, preferentially a pulling force, on the first leg of the user and/or on the second leg of the user based on the actuator control signal. The actuator may be mountable on the user, such as on the harness worn by the user. For example, the harness may comprise a waist belt configured to be worn by the user, wherein the actuator is mountable on the waist belt. The actuator may be configured as a rotary actuator having a rotatable drive shaft.

The actuator may further comprise at least one first tendon at least partially wound around the rotatable drive shaft, preferably wound in a first direction (e.g., clockwise) around the drive shaft. The at least one first tendon may further be fixedly connected to the first leg belt. The actuator may further comprise at least one second tendon at least partially wound around the rotatable drive shaft, preferably wound in a second direction (e.g., counter-clockwise) around the drive shaft opposite the first direction. The at least one second tendon may further be fixedly connected to the second leg belt. Therefore, the actuator may be configured to rotate, in particular based on the actuator control signal, the drive shaft to wind-up and/or unwind the at least one first tendon and the at least one second tendon, respectively, to exert the at least one force on the first leg and/or the second leg, respectively.

However, the actuator is not limited to such a configuration. For example, the actuator may alternatively comprise a first tendon at least partially wound around the rotatable drive shaft. The first tendon may be fixedly connected to the first leg belt at a first end of the first tendon and may be fixedly connected to the second leg belt at a second end of the first tendon, wherein the first tendon is at least partially wound around the rotatable drive shaft between the first and second end of the first tendon. Therefore, the actuator may be configured to rotate, in particular based on the actuator control signal, the rotatable drive shaft to exert the at least one force on the first leg and/or the second leg, respectively.

The hip joint reference trajectory unit may be configured to receive, from the first sensor unit, the angular hip joint position of the first hip, and to receive, from the second sensor unit, the angular hip joint position of the second hip. The hip joint reference trajectory unit may be configured to determine an inter-limb flexion angle as a difference of the angular hip joint position of the first hip and the angular hip joint position of the second hip. The hip joint reference unit may be further configured to determine the angular hip velocity, for example as an inter-limb flexion angular velocity, based on the inter-limb flexion angle, for example as a time derivative of the inter-limb flexion angle.

The hip joint reference trajectory unit may be further configured to generate, using the gait phase estimation model, the hip joint reference trajectory θ_{ref}(t) based on the received hip angular state information, preferentially based on the determined inter-limb flexion angle and the determined inter-limb flexion angular velocity.

The actuation feedback unit may be configured to receive a current actuator state of the actuator, and compare the current actuator state with the hip joint reference trajectory θ_{ref}(t) to generate an actuator control signal, wherein the actuation control unit is configured to output the actuator control signal to control the actuator. In particular the actuator control signal may be a symmetrical control signal.

Any sensor unit described herein that is mountable to the at least one leg of the user may be configured to be mountable on a lateral side of a respective leg of the user. In particular, the lateral side may for example be a lateral side of a respective first leg belt and/or second leg belt.

Any tendon described herein may for example be a cable, wherein each cable may at least partially be surrounded by a corresponding Bowden sheath (for example between an actuator and a waist belt worn by the user). An exemplary cable may be a Kevlar cable, such as a black braided Kevlar fibre (such as the commercially available cable KT5703-06, 2.2 kN max. load, Loma Linda CA, USA) However, the tendons are not restricted thereto, and other types of force transfer elements may be provided. For example, one or more tendons may be implemented as straps, for example fabric straps. Each force transfer element may be connectable to a corresponding actuator and at least one anchor point, where the at least one anchor point is arrangeable proximal to the user, such as on a harness mounted on the user. The at least one anchor point may be arrangeable on the harness according to the walking assistance to be provided. For example, for walking assistance provided to a walking movement involving hip flexion, the at least one anchor point may be arrangeable on a front side of a respective thigh of the user. However, other and/or more arrangements of the at least one anchor points may be implemented, such as for example according to the individual requirements of the user.

By providing such an assistance system, as described herein, a three-layer system comprising a sensing layer comprising one or more sensors, a control layer comprising the actuation control unit, and an actuation layer, comprising one or more actuators may be implemented. In addition, the actuation control unit may be configured as a three-layer actuation control unit comprising a high-level layer for gait phase estimation, a middle-level layer for determination of the hip joint reference trajectory, and a low-level layer for generation of the actuator control signal. Therefore, the actuation control unit may be configured to enable an efficient software-hardware interaction between the three-layer system and the three-layer operational method of the actuation control unit.

The assistance system may further comprise at least one power source configured to provide power to at least one component of the assistance system, such as for example the actuation control unit, the first sensor unit, the second sensor unit, the first actuator, and/or the second actuator. The at least one power source may be rechargeable. An exemplary power source may be a, preferentially rechargeable, lithium polymer battery and/or lithium-ion battery. However, other types of power sources may be implemented.

In particular, a main power source may be provided to power multiple components of the assistance system. Such a main power source may allow better centralisation of weight and bulk of the assistance system, and may allow easier charging and/or replacement of the main power source. The main power source may be releasably connectable to at least one component of the assistance system to power said at least one component. This may allow for easier mounting of the assistance system on a user and/or facilitate charging of the main power source. The main power source may, for example, be mountable on the waist belt of a harness of the assistance system.

Alternatively, one or more components of the assistance system may be provided with their own, dedicated power sources. For example, the first sensor unit may be provided with a first sensor power source configured to provide power to the first sensor. Such an approach may allow a more efficient power distribution and management of the assistance system, as different components of the assistance system may have different power requirements and/or may require power at different times. Furthermore, power routing within the assistance system may be significantly facilitated thereby, as a number of power cable elements configured to transfer power between the at least one power source and the one or more components may be reduced. In addition, this may allow, for example, a harness of the assistance system to be provided as a modular harness, which may for example further enable facilitated mounting and dismounting of the assistance system.

The assistance system may further comprise at least one operational data collecting unit. The operational data collecting unit may be configured to collect operational data of one or more components of the assistance system. Operational data may be indicative of an operational state of respective one or more component. Operational data may for example comprise energy storage levels of the at least one power source, power consumption data of the one or more components, internal state information of the one or more components, one or more data signals generated by the one or more components, such as the actuator control signal, and/or one or more error indicators. The operational data collecting unit may be configured to process the collected operational data to monitor a correct functioning of the assistance system. The operational data collecting unit may be configured to at least partially store the collected operational data and/or output the collected operational data. For example, it may therefore be possible to obtain historical usage data of the assistance system and/or historical diagnostic data relating to the functioning of the assistance system.

The assistance system may further have multiple hardware implementations. For example, the assistance system may be a rigid exoskeleton or a soft exosuit. The assistance system may be an under-actuated assistance system or a fully-actuated assistance system. Furthermore, the assistance system may be a tendon-driven assistance system, but other implementations may also be provided. Therefore, the assistance system, as described herein, allows for a very high degree of variation in hardware configurations and/or offer high degrees of hardware generalization.

Furthermore, the assistance system may also comprise an environment monitoring unit. The environment monitoring unit may be configured to monitor an environment of the assistance system, such as for example a ground environment in a walking direction and/or in front of the user. For example, the environment monitoring unit may comprise one or more sensors, such as optical sensors and/or cameras, to measure the environment of the assistance system. The environment monitoring unit may be configured to obtain, for example via the one or more sensors and/or via computer vision, environment data indicative of the environment of the assistance system. The environment data may for example comprise a classification of the environment, such as “flat ground”, “stairs up”, “stairs down”, “ramp up”, and/or “ramp down” to name just a few non-limiting examples. The environment data may further comprise quantitative data of the environment, such as surface model and/or description, slopes, obstacles, etc. Based on the environment data, the assistance system and/or the actuation feedback unit and/or the actuation control unit may be configured to modulate the generated actuator control signal to account for the environment of the assistance system. Therefore, the assistance system may be further configured to provide walking assistance to the user based, at least in part, on the environment of the assistance system.

Thus, the assistance system may be configured to accommodate a further control layer that allows walking assistance modulation according to the surrounding environment of the assistance system. This may be particularly advantageous, if the user has to climb stairs or traverse ramps instead of walking level ground, thereby improving overall performance and reliability.

According to a further aspect, a computer-implemented method for controlling an assistance system configured to provide walking assistance to a user by assisting a walking movement of at least one leg of the user is disclosed. The method comprises receiving hip angular state information of at least one hip of the at least one leg, generating, using a gait phase estimation model, a hip joint reference trajectory θ_{ref}(t) based on the received hip angular state information, receiving a current actuator state of an actuator configured to assist the walking movement, comparing the current actuator state with the hip joint reference trajectory θ_{ref}(t) to generate an actuator control signal, and outputting the actuator control signal to control the actuator.

In particular, the method may comprise any combination of features, as described herein, such as for the described assistance system.

According to a further aspect, a non-transitory computer-readable storage medium comprising instructions that, when executed by a computing system, cause the computing system to perform the method for controlling an assistance system configured to provide walking assistance to a user by assisting a walking movement of at least one leg of the user. The instructions may comprise instructions for causing the computer system to perform the steps of receiving hip angular state information of at least one hip of the at least one leg, generating, using a gait phase estimation model, a hip joint reference trajectory θ_{ref}(t) based on the received hip angular state information, receiving a current actuator state of an actuator configured to assist the walking movement, comparing the current actuator state with the hip joint reference trajectory θ_{ref}(t) to generate an actuator control signal, and outputting the actuator control signal to control the actuator.

In particular, the storage medium may comprise any combination of features, as described herein, such as for the described assistance system and/or the described method.

Aspects and embodiments of the present disclosure will now be further explained in relation to the appended Figures. Any exemplary embodiments shown in the Figures and described below should not, however, be interpreted as limiting the scope of the invention.

### The Figures Show:

FIG. 1: a schematic overview of an exemplary assistance system;

FIG. 2: an exemplary determination of a polar angle;

FIG. 3: an exemplary polar angle and estimation of the estimated gait phase φ(t);

FIG. 4: an exemplary assistance system;

FIG. 5: an exemplary computer-implemented method;

FIG. 6: an exemplary graph of the hip joint reference trajectory θ_{ref}(t) and polar angle;

FIG. 7: an exemplary graph of the hip joint reference trajectory θ_{ref}(t) and the angular hip joint position for a fully actuated walking assistance system;

FIG. 8: an exemplary graph of the hip joint reference trajectory θ_{ref}(t) and an inter-limb flexion angle for an under-actuated walking assistance system;

FIG. 9: a schematic overview of an operation of an under-actuated walking assistance system;

FIG. 10: a schematic overview of an operation of a fully actuated walking assistance system; and

FIG. 11A-C: schematic overviews over possible exemplary tendon arrangements for assisting walking movements including different exemplary leg movements.

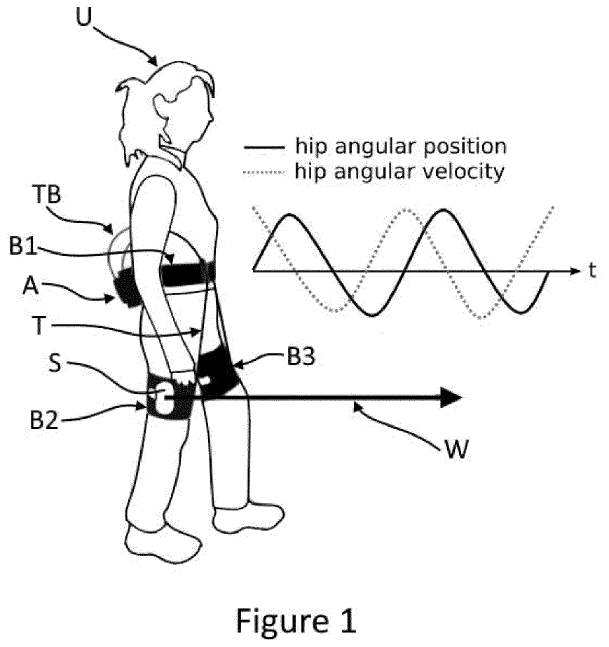

FIG. 1 shows a schematic overview of an exemplary assistance system 100.

A user U is shown during an exemplary walking movement W, wherein the user U walks substantially straight in a forward direction.

The user U further wears a harness of the exemplary assistance system 100, wherein the harness comprises at least a waist belt B1, a first thigh belt B2, and a second thigh belt B3.

The waist belt B1 is mounted on the user U in a waist region of the user U and configured to smoothly conform to the user's waist. The waist belt B1 may for example be made from a flexible fabric and/or elastomer. An exemplary actuator A is mounted on the waist belt B1 such that the actuator A may be worn by the user U during the walking movement W.

The first thigh belt B2 is mounted on the user U in a thigh region of a right thigh, in particular proximal to the right knee, of the user U and configured to smoothly conform to the user's right thigh. The first thigh belt B2 may for example be made from a flexible fabric and/or elastomer. An exemplary first sensor unit S is mounted on the first thigh belt B2, in particular on a lateral side of the first thigh belt B2, such that the first sensor unit S may be worn by the user U during the walking movement W. Furthermore, the first sensor unit S is configured to determine an angular hip joint position and/or an angular hip joint velocity of the user U, as for example shown in the inserted graph in FIG. 1. It is understood that the determined angular hip joint position and angular hip joint velocity, as shown in FIG. 1, are intended to be illustrative/exemplary only.

The second thigh belt B3 is mounted on the user U in a thigh region of a left thigh, in particular proximal to the left knee, of the user U and configured to smoothly conform to the user's left thigh. The second thigh belt B3 may for example be made from a flexible fabric and/or elastomer. An exemplary second sensor unit (not shown due to illustrative, perspective circumstances) may be mounted on the second thigh belt B3, in particular on a lateral side of the second thigh belt B3, such that the second sensor unit may be worn by the user U during the walking movement W. Furthermore, the second sensor unit may be configured similarly to the first sensor unit S.

In particular, the actuator A may comprise two tendons T, shown as two exemplary cables, extending from the actuator A to the first thigh belt B2 and the second thigh belt B3, respectively. The tendons T may each be at least partially surrounded by a corresponding Bowden sheath TB, such as in a region between the actuator A and the waist belt B1. The actuator A may be configured to exert a pulling force on the tendons T to assist the walking movement W of the user U.

An actuation control unit (not explicitly shown) may be configured to receive the angular hip joint position and/or the angular hip joint velocity measured by the first sensor unit S and the second sensor unit. The actuation control unit may be configured to generate an actuator control signal based on the received angular hip joint position and/or angular hip joint velocity. The actuator control signal may be output to the actuator A to control the actuator A.

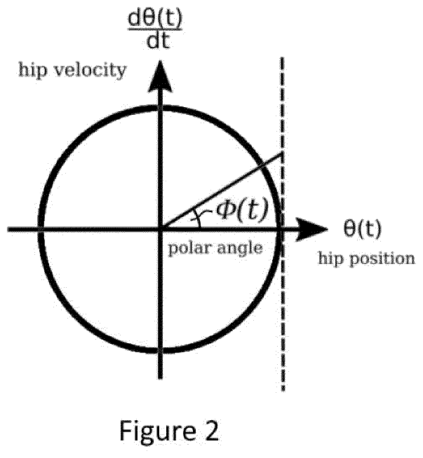

FIG. 2 shows an exemplary determination of a polar angle.

The polar angle may be a polar angle between the angular hip joint position and the angular hip velocity in a hip-phase-portrait. Alternatively, the polar angle may be a polar angle between an inter-limb flexion angle and an inter-limb flexion angular velocity in a hip-phase-portrait. Specifically, the polar angle may be the angle between the angular hip joint position θ(t) and the hip angular velocity \dot{θ}(t) in hip phase space, and may be indicative of a progression of the walking movement along a gait cycle.

A hip-phase-portrait may be understood as a graphical representation of hip kinematics of the at least one hip in hip phase space, as shown in FIG. 2. In particular, the hip phase space is a mathematical space spanned by an angular hip joint position abscissa axis and a hip angular velocity ordinate axis, as shown. Based on the received angular hip joint position and hip angular velocity at any timepoint t, a corresponding hip kinematic position may be determined in the hip phase space, for which a corresponding polar angle may be determined from the hip-phase-portrait.

Furthermore, during the walking movement of the user the angular hip joint position θ(t) and the hip angular velocity \dot{θ}(t) may each exhibit a periodic trajectory. The hip angular velocity \dot{θ}(t) may have a π/2 shift with respect to the angular hip joint position θ(t). Therefore, the angular hip joint position θ(t) and the hip angular velocity \dot{θ}(t) may produce a circular orbit in hip phase space, as represented by the circle in FIG. 2.

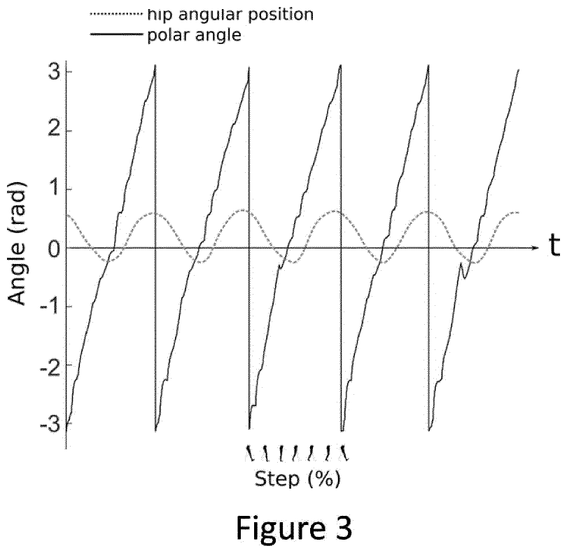

FIG. 3 shows an exemplary polar angle and estimation of the estimated gait phase φ(t). It is noted that the data shown in FIG. 3 corresponds to exemplary data that is not to be interpreted as limiting the scope of the disclosure. In particular, the exemplary data shown in FIG. 3 corresponds to experimental data obtained using an exemplary assistance system according to the present disclosure worn by a user during an outdoor walking session.

In particular, the gait phase estimation model is configured to determine an estimated gait phase φ(t) indicative of a progression of the walking movement along the gait cycle based on the polar angle, for example as determined in hip phase space, as shown in FIG. 2. As shown in FIG. 3, the polar angle may follow a function of the angular hip joint position (denoted as hip angular position in FIG. 3). In the shown example, the angular hip joint position is an inter-limb flexion angle, as described herein, and is based on exemplary data received from an exemplary sensor unit.

Consequently, the estimated gait phase φ(t) may be obtained as a function of the angular hip joint position θ(t) and the hip angular velocity \dot{θ}(t) (i.e., as φ(t)=f([θ(t), \dot{θ}(t)])).

FIG. 3 in particular shows both the inter-limb flexion angle as the angular hip joint position θ(t) during a typical walking cycle of a user U, and a correspondingly determined polar angle. Specifically, as illustrated below the graph of FIG. 3, the polar angle may be indicative of a progression of the user along a walking cycle.

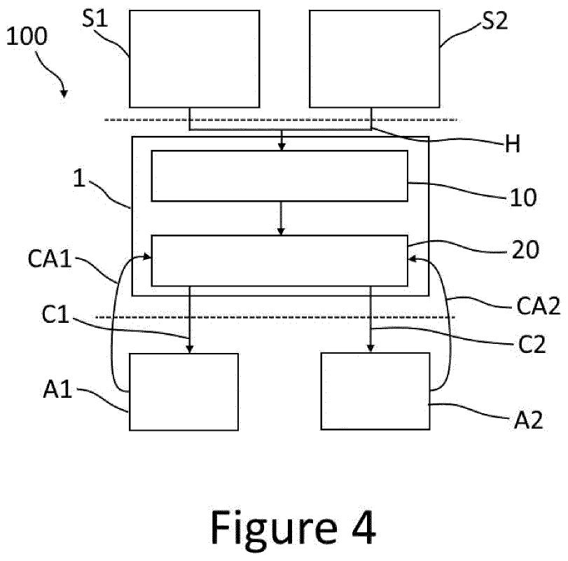

FIG. 4 shows an exemplary assistance system 100.

The assistance system 100 is configured to provide walking assistance to a user U by assisting a walking movement of at least one leg of the user U.

The assistance system 100 may comprise a first sensor unit S1 configured to determine an angular hip joint position and an angular hip velocity of a first hip of the first leg of the user U. The first sensor unit S1 may be mountable on the first leg of the user U, such as on a harness worn by the user U at least partially on the first leg.

The first sensor unit S1 may be configured to provide, as part of a hip angular state information H, the angular hip joint position and an angular hip velocity of the first hip to a hip joint reference trajectory unit 10 of an actuation control unit 1.

The assistance system 100 may further comprise a second sensor unit S2 configured to determine an angular hip joint position and an angular hip velocity of a second hip of the first leg of the user U. The second sensor unit S2 may be mountable on the second leg of the user U, such as on the harness worn by the user U at least partially on the second leg.

The second sensor unit S2 may be configured to provide, as part of the hip angular state information H, the angular hip joint position and an angular hip velocity of the second hip to the hip joint reference trajectory unit 10 of the actuation control unit 1.

The assistance system 100 is however not restricted to such an implementation, and may for example comprise more, less or no sensor units. In particular the assistance system 100 may for example be connectable to one or more sensor units to receive the hip angular state information H, without comprising the respective sensor units.

The assistance system 100 further comprises the actuation control unit 1. The actuation control unit 1 may be configured to generate at least an actuator control signal C1, C2 to control an actuator A1, A2.

The actuation control unit 1 comprises a hip joint reference trajectory unit 10. The hip joint reference trajectory unit 10 is configured to receive the hip angular state information H of at least one hip of the user U, such as of the first hip and the second hip of the user U.

The hip joint reference trajectory unit 10 is further configured to generate, using a gait phase estimation model, a hip joint reference trajectory θ_{ref}(t) based on the received hip angular state information H. The hip joint reference trajectory θ_{ref}(t) may, in the present example, comprise a first hip joint reference trajectory θ_{ref,1}(t) and a second hip joint reference trajectory θ_{ref,2}(t) for the first hip and the second hip, respectively. The gait phase estimation model may be configured to estimate, based on individual parameters of the user U, a current and/or future physical state of the at least one hip. The hip joint reference trajectory unit 10 is configured to output the hip joint reference trajectory θ_{ref}(t).

The actuation control unit 1 further comprises an actuation feedback unit 20. The actuation feedback unit 20 is configured to receive the hip joint reference trajectory θ_{ref}(t) from the hip joint reference trajectory unit 10.

The actuation feedback unit 20 is further configured to receive a current actuator state CA1, CA2 of an actuator A1, A2 configured to assist the walking movement of the user U. The current actuator state CA1, CA2 may comprise a current actuation state of the actuator A1, A2.

In the present, exemplary assistance system 100, the actuation feedback unit 20 is configured to receive a first current actuator state CA1 from a first actuator A1 and a second current actuator state CA2 from a second actuator A2. The first and second actuators A1, A2 may for example be rotary actuators configured to exert a pulling force on a tendon connected to the first hip and the second hip, respectively, to exert a force on the first hip and the second hip, respectively.

The actuation feedback unit 20 is connectable to the first actuator A1 and the second actuator A2 to output a first actuator control signal C1 and a second actuator control signal C2.

The actuation feedback unit 20 is further configured to compare the first current actuator state CA1 with the first hip joint reference trajectory θ_{ref,1}(t) to generate the first actuator control signal C1. The actuation feedback unit 20 is further configured to compare the second current actuator state CA2 with the second hip joint reference trajectory θ_{ref,1}(t) to generate the second actuator control signal C2.

The actuation control unit 1 is further configured to output the first actuator control signal C1 to control the first actuator A1 and to output the second actuator control signal C2 to control the second actuator A2.

The assistance system 100 may in particular comprise the first actuator A1 and the second actuator A2, but is not restricted to such an implementation, and may for example comprise more, less or no actuators. In particular the assistance system 100 may for example be connectable to one or more actuators to output an actuator control signal to any such one or more actuators.

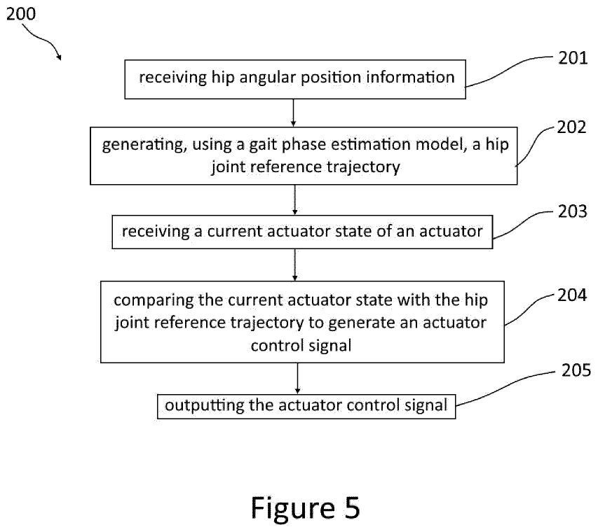

FIG. 5 shows an exemplary computer-implemented method 200 for controlling an assistance system 100 configured to provide walking assistance to a user U by assisting a walking movement of at least one leg of the user U.

In a first step 201, the method 200 comprises receiving hip angular state information H of at least one hip of the at least one leg. In a second step 202, the method 200 further comprises generating, using a gait phase estimation model, a hip joint reference trajectory θ_{ref}(t) based on the received hip angular state information H.

The method 200 further comprises, in a third step 203, receiving a current actuator state of an actuator configured to assist the walking movement. In a further step 204, the method 200 comprises comparing the current actuator state with the hip joint reference trajectory θ_{ref}(t) to generate an actuator control signal.

At step 205, the method 200 comprises outputting the actuator control signal to control the actuator.

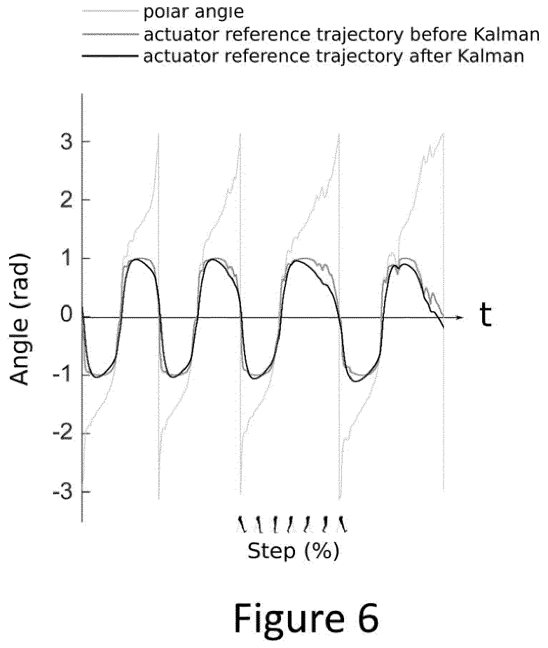

FIG. 6 shows an exemplary graph of the hip joint reference trajectory θ_{ref}(t) (denoted as actuator reference trajectory in FIG. 6) and polar angle, wherein an exemplary influence of the application of a Kalman filter is illustrated. In particular, the hip joint reference trajectory θ_{ref}(t) may be generated based on the approximated dynamic behaviour θᵣ(t) (which may be generated based at least in part on the polar angle, as described herein), wherein the Kalman filter may be applied to said approximated dynamic behaviour θᵣ(t) prior to the generation of the hip joint reference trajectory θ_{ref}(t).

It is noted that the data shown in FIG. 6 corresponds to exemplary data that is not to be interpreted as limiting the scope of the disclosure. In particular, the exemplary data shown in FIG. 6 corresponds to and/or is based on experimental data obtained using an exemplary assistance system according to the present disclosure worn by a user during an outdoor walking session.

In particular, as can be seen, noise from the hip angular state information, e.g., as illustrated in the graph of the polar angle, is also present in the hip joint reference trajectory θ_{ref}(t) before application of the Kalman filter, wherein such noise is significantly reduced in the hip joint reference trajectory θ_{ref}(t) after application of the Kalman filter.

Therefore, a robustness of the hip joint reference trajectory θ_{ref}(t) may be significantly improved by the application of a Kalman filter, as described herein.

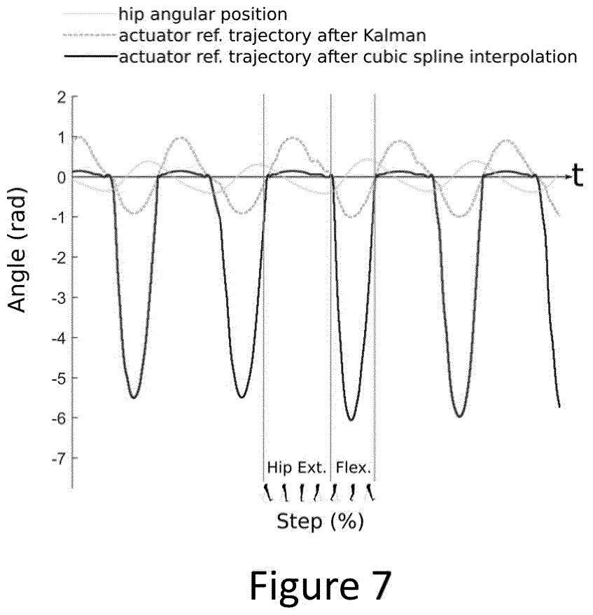

FIG. 7 shows an exemplary graph of an exemplary hip joint reference trajectory θ_{ref}(t) (denoted as actuator ref. trajectory in FIG. 7) and an exemplary angular hip joint position (denoted as hip angular position in FIG. 7) for a fully actuated walking assistance system, wherein an exemplary influence of the application of an interpolation, as described herein, is illustrated. It is noted that signal amplitudes illustrated in the graph of FIG. 7 may be dependent on a hardware design of the exemplary fully actuated walking assistance system.

An approximate dynamic behaviour θᵣ(t), as described herein, may be generated based at least in part on the shown angular hip joint position of a first hip.

A hip joint reference trajectory θ_{ref}(t) may be generated by the hip joint reference trajectory unit based on the approximate dynamic behaviour θᵣ(t), wherein a Kalman filter may be applied to said approximated dynamic behaviour θᵣ(t) prior to the generation of the hip joint reference trajectory θ_{ref}(t). Such a hip joint reference trajectory θ_{ref}(t) is shown by the dashed line in FIG. 7.

Alternatively, a hip joint reference trajectory θ_{ref}(t) may be generated by the hip joint reference trajectory unit based on the approximate dynamic behaviour θᵣ(t), wherein a Kalman filter and an interpolation, as described herein, may be applied to said approximated dynamic behaviour θᵣ(t) prior to the generation of the hip joint reference trajectory θ_{ref}(t). The applied interpolation may be a cubic spline interpolation, as described herein. Such a hip joint reference trajectory θ_{ref}(t) is shown by the thick, solid line in FIG. 7.

The generated hip joint reference trajectory θ_{ref}(t) after application of the Kalman filter and the interpolation may be provided to the actuation feedback unit to generate the actuator control signal to control an actuator in a fully actuated walking assistance system, as described above. In particular, in such fully actuated walking assistance systems, one actuator may be provided for each leg of the user, such as the first leg.

Furthermore, as can be seen from FIG. 7, in a fully actuated system, the gait cycle of the first leg of the user may be divided into a hip extension region and a hip flexion region. In addition, in the shown system, the actuator control signal may be configured to control the actuator to apply a pulling force on a corresponding force transfer element, such as a tendon connected to the first leg, in the hip flexion region, and to control the actuator to provide slack in the force transfer element in the hip extension region. This may be further indicated by the change of sign of the generated hip joint reference trajectory θ_{ref}(t) after application of the interpolation.

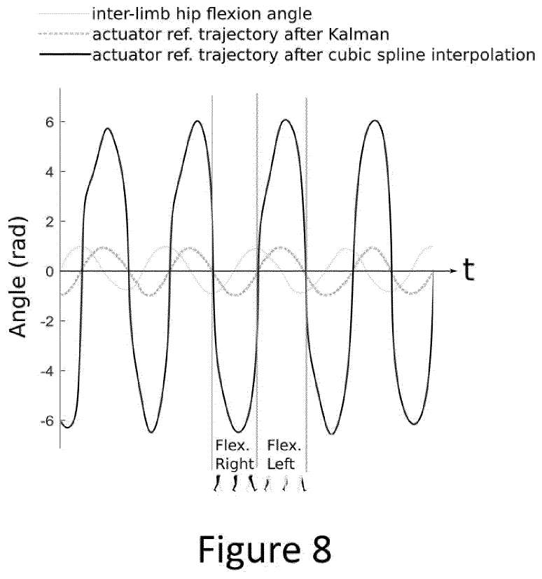

FIG. 8 shows an exemplary graph of an exemplary hip joint reference trajectory θ_{ref}(t) (denoted as actuator ref. trajectory in FIG. 8) and an exemplary inter-limb flexion angle (denoted as inter-limb hip flexion angle in FIG. 8) for an under-actuated walking assistance system, wherein an exemplary influence of the application of an interpolation is illustrated. In particular, an under-actuated walking assistance system may comprise one actuator for both legs of the user to which assistance is to be provided. It is further noted that signal amplitudes illustrated in the graph of FIG. 8 may be dependent on a hardware design of the exemplary under-actuated walking assistance system.

An approximate dynamic behaviour θᵣ(t), as described herein, may be generated based at least in part on the shown inter-limb flexion angle.

A hip joint reference trajectory θ_{ref}(t) may be generated by the hip joint reference trajectory unit based on the approximate dynamic behaviour θᵣ(t), wherein a Kalman filter may be applied to said approximated dynamic behaviour θᵣ(t) prior to the generation of the hip joint reference trajectory θ_{ref}(t). Such a hip joint reference trajectory θ_{ref}(t) is shown by the dashed line in FIG. 8.

Alternatively, a hip joint reference trajectory θ_{ref}(t) may be generated by the hip joint reference trajectory unit based on the approximate dynamic behaviour θᵣ(t), wherein a Kalman filter and an interpolation, as described herein, may be applied to said approximated dynamic behaviour θᵣ(t) prior to the generation of the hip joint reference trajectory θ_{ref}(t). The applied interpolation may be a cubic spline interpolation, as described herein. Such a hip joint reference trajectory θ_{ref}(t) is shown by the thick, solid line in FIG. 8.

Furthermore, as can be seen from FIG. 8, in such an under-actuated walking assistance system, the gait cycle of the user may be divided into a hip flexion region of the right leg of the user and a hip flexion region of the left leg of the user. In addition, in the shown system, the actuator control signal may be configured to control the actuator to apply a pulling force on a corresponding first force transfer element, such as a tendon connected to the right leg, in the hip flexion region of the right leg, and to control the actuator to apply a pulling force on a corresponding second force transfer element, such as a tendon connected to the left leg, in the hip flexion region of the left leg. In addition, as the exemplary system is under-actuated, applying a pulling force to one of the first or second force transfer element provides slack in the other of the first and second force transfer element.

Furthermore, the values along the y-axis of FIG. 8 may reflect the radius of a pulley of the actuator and a rotation direction of the actuator.

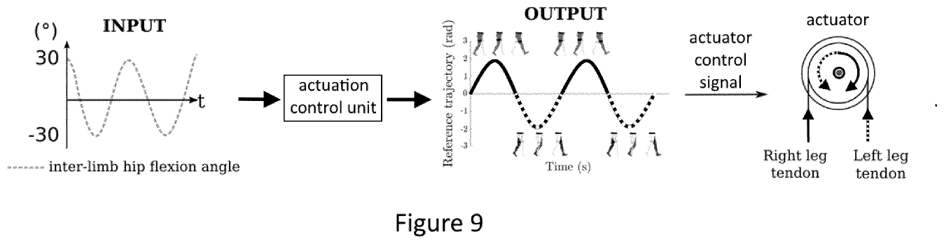

FIG. 9 shows a schematic overview of an operation of an exemplary under-actuated walking assistance system, as described herein. The exemplary under-actuated walking assistance system may be configured to provide walking assistance to a user by assisting a walking movement of both legs of the user.

The exemplary walking assistance system may comprise an actuation control unit, wherein the actuation control unit comprises a hip joint reference trajectory unit and an actuation feedback unit, as described herein.

The actuation control unit may be configured to receive, as input, hip angular state information, wherein the hip angular state information comprises an inter-limb flexion angle, as described herein. The inter-limb flexion angle may be determined as a difference between an angular hip joint position of the first and second hips of the user.

The actuation control unit may be further configured to generate, based on the received hip angular state information, a hip joint reference trajectory. The actuation control unit may be configured to compare the hip joint reference trajectory with a received current actuator state of an actuator of the under-actuated walking assistance system to generate and output the actuator control signal to control the actuator.

The actuator may for example be a rotary actuator comprising a pulley rotatable around a rotation axis, wherein a right leg tendon and a left leg tendon are at least partially wound around the pulley. The right leg tendon may be connected to a right leg of the user and the left leg tendon may be connected to a left leg of the user, such that rotation of the pulley by the actuator may exert a pulling force on either the right leg or the left leg.

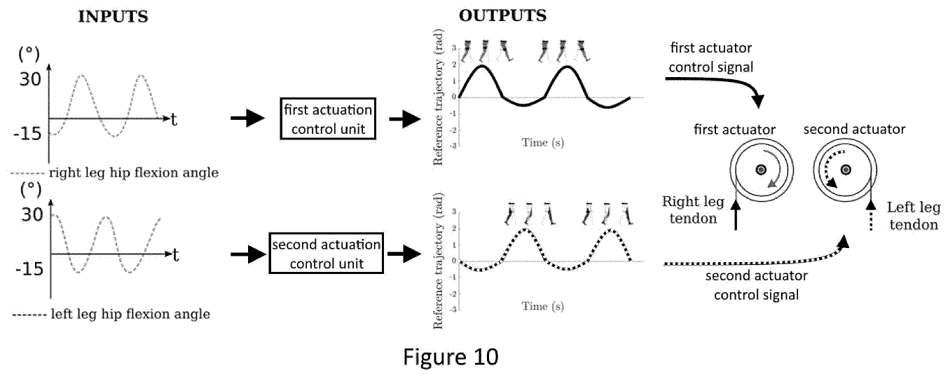

FIG. 10 shows a schematic overview of an operation of an exemplary fully actuated walking assistance system, as described herein. The exemplary fully actuated walking assistance system may be configured to provide walking assistance to a user by assisting a walking movement of both legs of the user.

The exemplary walking assistance system may comprise a first actuation control unit, wherein the first actuation control unit comprises a first hip joint reference trajectory unit and a first actuation feedback unit, as described herein.

The first actuation control unit may be configured to receive, as input, first hip angular state information, wherein the first hip angular state information comprises a first hip flexion angle of the first (e.g., right) hip of the user, as described herein.

The first actuation control unit may be further configured to generate, based on the received first hip angular state information, a first hip joint reference trajectory. The first actuation control unit may be configured to compare the first hip joint reference trajectory with a received first current actuator state of a first actuator of the fully actuated walking assistance system to generate and output a first actuator control signal to control the first actuator.

The first actuator may for example be a rotary actuator comprising a first pulley rotatable around a first rotation axis, wherein a right leg tendon is at least partially wound around the first pulley. The right leg tendon may be connected to a right leg of the user, such that rotation of the first pulley by the first actuator may exert a pulling force on the right leg.

The exemplary walking assistance system may comprise a second actuation control unit, wherein the second actuation control unit comprises a second hip joint reference trajectory unit and a second actuation feedback unit, as described herein.

The second actuation control unit may be configured to receive, as input, second hip angular state information, wherein the second hip angular state information comprises a second hip flexion angle of the second (e.g., left) hip of the user, as described herein.

The second actuation control unit may be further configured to generate, based on the received second hip angular state information, a second hip joint reference trajectory. The second actuation control unit may be configured to compare the second hip joint reference trajectory with a received second current actuator state of a second actuator of the fully actuated walking assistance system to generate and output a second actuator control signal to control the second actuator.

The second actuator may for example be a rotary actuator comprising a second pulley rotatable around a second rotation axis, wherein a left leg tendon is at least partially wound around the second pulley. The left leg tendon may be connected to a left leg of the user, such that rotation of the second pulley by the second actuator may exert a pulling force on the left leg.

In particular, the first actuator control signal and the second actuator control signal may be out of phase from one another. Furthermore, the first actuator signal may be convertible into the second actuator signal by phase shifting the first actuation signal.

In such a case, the provision of a second actuation control unit may be omitted.

The first and second actuation control units may be independent from one another. Alternatively, the first and second actuation control units may share data and/or power between them.

The first and second actuators may be independent from one another. However, the first and second actuators are not limited thereto. For example, the first and second actuators may be comprised by a common actuator module.

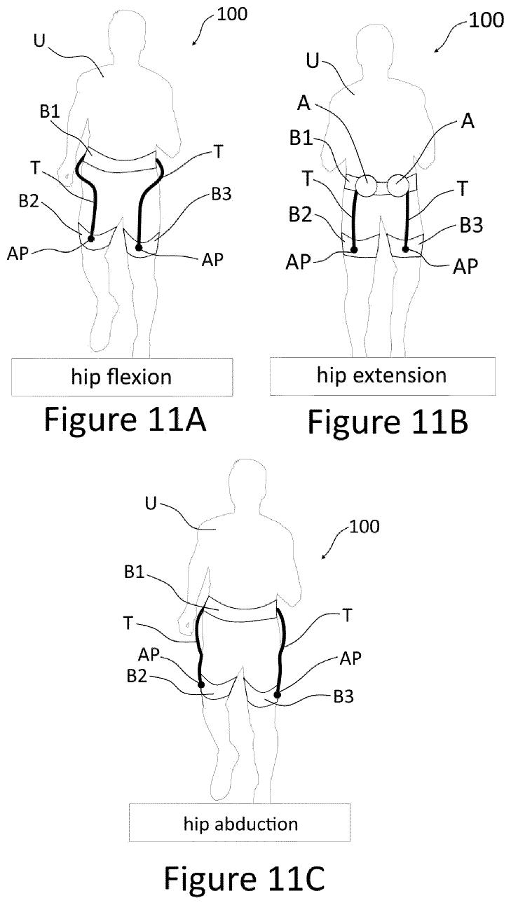

FIGS. 11A to 11C show schematic overviews over possible exemplary tendon arrangements for assisting walking movements including different exemplary leg movements, such as hip flexion, hip extension, and hip abduction.

FIG. 11A shows an exemplary assistance system 100 worn by a user U during an exemplary walking movement W. The shown exemplary walking movement W may comprise a hip flexion of the hips of the user U. FIG. 11A shows a perspective view of the user U from a front of the user U.

The exemplary walking assistance system 100 may comprise a harness worn by the user U, wherein the harness comprises at least a waist belt B1, a first thigh belt B2, and a second thigh belt B3.

The waist belt B1 may be worn by the user in a waist region of the user U, wherein one or more actuators A may be mounted on the waist belt B1. In FIG. 11A, said one or more actuators A are mounted proximal to the user's back, and are therefore not shown.

The first thigh belt B2 is mounted on the user U in a thigh region of a right thigh of the user U, while the second thigh belt B3 is mounted on the user U in a thigh region of a left thigh of the user U.

The exemplary assistance system 100 may comprise two (schematically illustrated) tendons T extending from the one or more actuators A to the first thigh belt B2 and the second thigh belt B3, respectively. Specifically, each tendon T may be connected to the one or more actuators A and to an anchor point AP on the respective first thigh belt B2 or second thigh belt B3.

In the presently shown exemplary assistance system 100 a walking movement W of the user U is assisted, wherein the walking movement W comprises a hip flexion of the hips of the user U. A location of the anchor points AP may be correspondingly chosen. For example, to assist hip flexion, the anchor points AP may be located centrally on a front side of the first thigh belt B2 and the second thigh belt B3, respectively. The front side of the first thigh belt B2 and the second thigh belt B3 may in particular be arranged on a front side of the respective thigh of the user U.

Therefore, the one or more actuators A may be configured to exert a pulling force on the tendons T to assist the walking movement W of the user U, in particular a hip flexion of the hips of the user U.

FIG. 11B shows an exemplary assistance system 100 worn by a user U during an exemplary walking movement W. The shown exemplary walking movement W may comprise a hip extension of the hips of the user U. FIG. 11B shows a perspective view of the user U from a back of the user U.

The exemplary walking assistance system 100 may comprise a harness worn by the user U, wherein the harness comprises at least a waist belt B1, a first thigh belt B2, and a second thigh belt B3. The waist belt B1 may be worn by the user in a waist region of the user U, wherein two actuators A may be mounted on the waist belt B1. The first thigh belt B2 is mounted on the user U in a thigh region of a right thigh of the user U, while the second thigh belt B3 is mounted on the user U in a thigh region of a left thigh of the user U.

The exemplary assistance system 100 may comprise two (schematically illustrated) tendons T, each extending from one of the actuators A to the first thigh belt B2 and the second thigh belt B3, respectively. Specifically, each tendon T may be connected to one of the actuators A and to an anchor point AP on the respective first thigh belt B2 or second thigh belt B3.

In the presently shown exemplary assistance system 100 a walking movement W of the user U is assisted, wherein the walking movement W comprises a hip extension of the hips of the user U. A location of the anchor points AP may be correspondingly chosen. For example, to assist hip extension, the anchor points AP may be located centrally on a back of the first thigh belt B2 and the second thigh belt B3, respectively. The back side of the first thigh belt B2 and the second thigh belt B3 may in particular be arranged on a back side of the respective thigh of the user U.

Therefore, the two actuators A may be configured to exert a pulling force on the respective tendons T to assist the walking movement W of the user U, in particular a hip extension of the hips of the user U.

FIG. 11C shows an exemplary assistance system 100 worn by a user U during an exemplary walking movement W. The shown exemplary walking movement W may comprise a hip abduction of the hips of the user U. FIG. 11C shows a perspective view of the user U from a front of the user U.

The exemplary walking assistance system 100 may comprise a harness worn by the user U, wherein the harness comprises at least a waist belt B1, a first thigh belt B2, and a second thigh belt B3. The waist belt B1 may be worn by the user in a waist region of the user U, wherein one or more actuators A (not shown) may be mounted on the waist belt B1. The first thigh belt B2 is mounted on the user U in a thigh region of a right thigh of the user U, while the second thigh belt B3 is mounted on the user U in a thigh region of a left thigh of the user U.

The exemplary assistance system 100 may comprise two (schematically illustrated) tendons T extending from the one or more actuators A to the first thigh belt B2 and the second thigh belt B3, respectively. Specifically, each tendon T may be connected to the one or more actuators A and to an anchor point AP on the respective first thigh belt B2 or second thigh belt B3.

In the presently shown exemplary assistance system 100 a walking movement W of the user U is assisted, wherein the walking movement W comprises a hip abduction of the hips of the user U. A location of the anchor points AP may be correspondingly chosen. For example, to assist hip abduction, the anchor points AP may be located centrally on a laterally outward side of the first thigh belt B2 and the second thigh belt B3, respectively. The laterally outward side of the first thigh belt B2 and the second thigh belt B3 may in particular be arranged on a laterally outward side of the respective thigh of the user U.

Therefore, the one or more actuators A may be configured to exert a pulling force on the tendons T to assist the walking movement W of the user U, in particular a hip abduction of the hips of the user U.

The invention is not to be limited by any of the herein described and/or shown exemplary embodiments. Instead, the invention is defined by the independent claims, wherein preferred embodiments form the subject of the dependent claims.

### REFERENCE SIGNS

1 Actuation control unit
10 Hip join reference trajectory unit
20 Actuation feedback unit
100 Assistance system
200 Method
201-205 Method steps
A, A1, A2 Actuator
AP Anchor point
S, S1, S2 Sensor unit
U User
W Walking movement
B1 Waist belt
B2 First thigh belt
B3 Second thigh belt
T Tendon
TB Bowden sheath
C1, C2 Actuator control signal
CA1, CA2 Current actuator state
H Hip angular state information

1.-14. (canceled)

15. An assistance system configured to provide walking assistance to a user by assisting a walking movement of at least one leg of the user, comprising:
an actuation control unit comprising:
a hip joint reference trajectory unit, configured to:
receive hip angular state information of at least one hip of the at least one leg, and
generate, using a gait phase estimation model, a hip joint reference trajectory based on the received hip angular state information,
an actuation feedback unit configured to:
receive a current actuator state of an actuator configured to assist the walking movement, and
compare the current actuator state with the hip joint reference trajectory to generate an actuator control signal,
wherein the actuation control unit is configured to output the actuator control signal to control the actuator.

16. The assistance system according to claim 15, wherein the gait phase estimation model is configured to determine a movement state of a hip during at least a portion of a walking cycle movement of a leg in dependence on at least one modelling parameter and/or the received hip angular state information,
wherein generating the hip joint reference trajectory comprises evaluating the at least one modelling parameter to fit the gait phase estimation model to the received hip angular state information.

17. The assistance system according to claim 15, wherein the hip angular state information comprises an angular hip joint position of the at least one hip and/or an angular hip velocity of the at least one hip, and
wherein the gait phase estimation model is configured to receive as input the angular hip joint position and/or the angular hip velocity to generate the hip joint reference trajectory.

18. The assistance system according to claim 17, wherein the gait phase estimation model is configured to:
determine a polar angle between the angular hip joint position and the angular hip velocity in a hip-phase-portrait,
determine an estimated gait phase indicative of a progression of the walking movement along a gait cycle based on the polar angle, and
approximate, based on the estimated gait phase, a dynamic behavior of the at least one hip, wherein the hip joint reference trajectory is generated based on the approximated dynamic behavior.

19. The assistance system according to claim 18, wherein the gait phase estimation model is further configured to:
prior to determining the estimated gait phase, center and normalize the angular hip joint position and the angular hip velocity, and
wherein the polar angle is determined between the centered and normalized angular hip joint position and the centered and normalized angular hip velocity.

20. The assistance system according to claim 18, wherein the gait phase estimation model is further configured to:
apply a Kalman filter to the approximated dynamic behavior of the at least one hip prior to generating the hip joint reference trajectory.

21. The assistance system according to claim 18, wherein the gait phase estimation model is further configured to:
generate the hip joint reference trajectory by applying an interpolation to the approximated dynamic behavior of the at least one hip.

22. The assistance system according to claim 15, wherein the actuation feedback unit is a Proportional-Integral-Differential, PID, controller.

23. The assistance system according to claim 17, further comprising:
a first sensor unit communicatively coupled to the actuation control unit and configured to determine an angular hip joint position and an angular hip velocity of a first hip of a first leg of the user; and
the actuator, wherein the actuator is configured to exert at least one force on the first leg of the user based on the actuator control signal,
wherein the actuation control unit is configured to generate the actuator control signal based on the angular hip joint position and the angular hip velocity of the first hip.

24. The assistance system according claim 17, further comprising:
a first sensor unit communicatively coupled to the actuation control unit and configured to determine at least an angular hip joint position of a first hip of a first leg of the user;
a second sensor unit communicatively coupled to the actuation control unit and configured to determine at least an angular hip joint position of a second hip of a second leg of the user,
wherein gait phase estimation model is configured to receive as input:
the angular hip position as an inter-limb flexion angle based on the angular hip joint position of the first hip and the angular hip joint position the second hip,
the angular hip velocity as an inter-limb flexion angular velocity based on the angular hip velocity of the first hip and the second hip; and
the actuator, wherein the actuator is configured to exert at least one force on the first leg of the user and/or on the second leg based on the actuator control signal.

25. The assistance system according to claim 17, further comprising:
a first sensor unit communicatively coupled to the actuation control unit and configured to determine an angular hip joint position and an angular hip velocity of a first hip of a first leg of the user,
wherein the hip joint reference trajectory unit is configured to generate a first hip joint reference trajectory based on the angular hip joint position and the angular hip velocity of the first hip,
wherein the actuation feedback unit is configured to receive a first current actuator state of a first actuator configured to exert at least one force on the first leg of the user,
wherein the actuation feedback unit is configured to compare the first actuator state to the first hip joint reference trajectory to generate a first actuator control signal;
a second sensor unit communicatively coupled to the actuation control unit and configured to determine an angular hip joint position and an angular hip velocity of a second hip of a second leg of the user,
wherein the hip joint reference trajectory unit is configured to generate a second hip joint reference trajectory based on the angular hip joint position and the angular hip velocity of the second hip,
wherein the actuation feedback unit is configured to receive a second current actuator state of a second actuator configured to exert at least one force on the second leg of the user,
wherein the actuation feedback unit is configured to compare the second actuator state to the second hip joint reference trajectory to generate a second actuator control signal;
the first actuator, wherein the first actuator is configured to exert at least one force on the first leg based on the first actuator control signal; and
the second actuator, wherein the second actuator is configured to exert at least one force on the second leg based on the second actuator control signal.

26. The assistance system according to claim 24, wherein the first sensor unit and/or the second sensor unit is mountable on a lateral side of a respective leg of the user.

27. The assistance system according to claim 25, wherein the first sensor unit and/or the second sensor unit is mountable on a lateral side of a respective leg of the user.

28. A computer-implemented method for controlling an assistance system configured to provide walking assistance to a user by assisting a walking movement of at least one leg of the user, comprising:
receiving hip angular state information of at least one hip of the at least one leg;
generating, using a gait phase estimation model, a hip joint reference trajectory based on the received hip angular state information;
receiving a current actuator state of an actuator configured to assist the walking movement;
comparing the current actuator state with the hip joint reference trajectory to generate an actuator control signal; and
outputting the actuator control signal to control the actuator.

29. A non-transitory computer-readable storage medium comprising instructions that, when executed by a computing system, cause the computing system to perform the method according to claim 28.
